(19) United States
(12) Patent Application Publication
(10) Pub. No.: US 2011/0218825 A1
(43) Pub. Date: Sep. 8, 2011

(54) THREE-DIMENSIONAL INTERACTIVE VEHICLE DAMAGE CLAIM INTERFACE

(75) Inventor: DAVID HERTENSTEIN, Irving, TX (US)

(73) Assignee: INTERNATIONAL BUSINESS MACHINES CORPORATION, ARMONK, NY (US)

(21) Appl. No.: 12/716,710

(22) Filed: Mar. 3, 2010

(51) Int. Cl. G06Q 40/00; G06F 3/048

(52) U.S. Cl. 705/4; 715/808; 715/849; 703/8

(57) ABSTRACT

A three-dimensional vehicle scene including an image can be rendered within an interactive user interface. The image can be generated from a model and can be rotatable by user selections of user selectable rotation controls. Vehicle panels can be shown and hidden within the interactive user interface responsive to positionings of an interface pointer. While one of the vehicle panels is shown, user-configurable damage fields can be included in the user interface to describe damage to the vehicle. Input of the damage fields can be used to indicate damage for insurance claim purposes and can be used to update damage indicia on the interface. Damage indicia can be overlaid on top of the image. A damaged vehicle can be shown in the interface by combining (in real-time and at runtime) the image of the undamaged vehicle and the damage indicia, which overlay the image.

### REFERENCE TO COMPUTER PROGRAMMING LISTING

The present application includes a computer program listing referred to as Appendix A which is being submitted electronically in accordance with MPEP §1.96(c) via EFS-Web filing interface. The referenced computer program listing, Appendix A, is being submitted separately as an ASCII .txt file. The computer program listing is entitled CHA9-2010-0003US1_Appendix_A.txt, and is incorporated herein by reference.

### BACKGROUND

The present invention relates to the field of insurance claim systems and, more particularly, to a 3-dimensional (3D) interactive vehicle damage claim interface.

Many companies are embracing the Internet as a means of reducing overhead and increasing customer interaction. Insurance companies are no exception. Many insurance companies currently provide customers with online access to account and policy information as well as policy quotes. However, capabilities provided for handling damage claims remains limited; typically, only capturing textual information for use by a claims agent who will create/submit the actual damage claim.

Currently, online insurance claims processing systems lack the ability for a customer to provide graphical details via a user interface to submit a damage claim. The insurance claims processing system described in U.S. Patent 20020035488 supports a user interface that allows a customer to assign predefined damage descriptors to areas of a graphic of a vehicle.

While the interface in US20020035488 is an improvement over current approaches, it does not allow the customer to create an accurate graphical representation of the vehicle damage. The interface of US 20020035488 utilizes a static 2D or 3D graphic of the vehicle. The customer is unable to modify the appearance or location of the damage upon the vehicle graphic. That is, a selection of damage descriptor for an area of the vehicle merely means that some form of that damage type appears somewhere in that area of the vehicle. Further, the appearance of the vehicle graphic does not change in response to the selection of a damage descriptor.

### BRIEF SUMMARY

One aspect of the disclosure can include a method and computer program product for capturing vehicle damage information in an interactive graphical user interface (GUI). In this aspect, a three-dimensional vehicle scene can be rendered within an interactive user interface. The three-dimensional vehicle scene can include an image of a vehicle generated from a three-dimensional vehicle model. The image of the vehicle within the three-dimensional vehicle scene is rotatable by user selections of user selectable rotation controls of the interactive user interface. Vehicle panels can be shown and hidden within the interactive user interface responsive to positionings of an interface pointer of the user interface relative to the image of the vehicle. Each of the vehicle panels can include a three dimensional plane for an exterior of the outer surface of the vehicle, wherein each vehicle panel is shown in the interactive user interface as an overlay to a portion of the image of the vehicle that corresponds to the vehicle panel. Adjustments to the vehicle panels can be made when the image of the vehicle is rotated by user selections of the rotation controls. While one of the vehicle panels is shown, a set of user-configurable damage fields can be presented to describe damage to the vehicle within a region of the vehicle corresponding to the one vehicle panel that is shown. Responsive to changes to values of the user configurable damage fields, damage to the vehicle can be determined. The determined damage can be visually presented in its corresponding location of the image within the interactive user interface.

One aspect of the disclosure can include a method and computer program product for handling vehicle damage using a user interface. In this aspect, a vehicle can be modeled using a three-dimensional vehicle model stored on a tangible storage medium. A set of vehicle panels can be defined for the vehicle model. Each of the vehicle panels can correspond to a specific one of a set of different discrete vehicle regions of the vehicle model. Each of the vehicle panels can include a three dimensional plane for an exterior of the outer surface of the vehicle. An image of the vehicle can be rendered within an interactive user interface. The image can be generated from the three-dimensional vehicle model. A presence of an interface pointer positioned over the image can be detected. One of the vehicle panels corresponding to one of the discrete vehicle regions that the interface pointer is pointing at a time of the detecting can be determined. The determined one of the vehicle panels can be shown in a visually delineated manner within the user interface. The vehicle panel can be shown as overlaying the corresponding one of the discrete regions of the image. Damage fields can be presented within the user interface for defining damage to vehicle panels. Bindings of the damage fields can be adjusted so that the damage fields refer to the determined one of the vehicle panels. Damage input entered into the damage fields can be received. The damage input can be specific to the determined one of the vehicle panels. The damage input can be stored within a damage panel object corresponding to the determined one of the vehicle panels. A repositioning of the interface pointer can be detected so that it is no longer pointing to the determined one of the panels. Responsive to detecting the repositioning, the determined one of the vehicle panels can be hidden within the user interface so that the user interface no longer shows the determined one of the vehicle panels as overlaying the corresponding one of the discrete regions of the image. Bindings of the damage fields can be adjusted so that the damage fields do not refer to the determined one of the vehicle panels or so that the damage fields are no longer presented within the user interface.

### BRIEF DESCRIPTION OF THE SEVERAL VIEWS OF THE DRAWINGS

FIG. 1 is a schematic diagram illustrating a system that utilizes a 3-dimensional (3D) interactive vehicle damage claim interface for capturing damage claim data for an insurance claim processing system in accordance with embodiments of the inventive arrangements disclosed herein.

FIG. 2 is a flow chart of a method describing the basic operation of a 3D interactive vehicle damage claim interface in accordance with an embodiment of the inventive arrangements disclosed herein.

FIG. 3 is an illustration of an example 3D interactive vehicle damage claim interface as presented within a Web browser in accordance with an embodiment of the inventive arrangements disclosed herein.

FIG. 3A illustrates the selection of a damage panel within the 3D interactive vehicle damage claim interface.

FIG. 3B is an illustration of auxiliary windows of the 3D interactive vehicle damage claim interface used to capture damage parameters for a selected damage panel.

FIG. 3C illustrates the change in appearance of the selected damage panel within the 3D interactive vehicle damage claim interface in response to damage parameter value changes.

### DETAILED DESCRIPTION

The present disclosure provides a solution that includes an interactive 3D user interface for collecting vehicle damage claim data. A 3D vehicle scene can be presented to a customer by a 3D interactive vehicle damage claim interface within a Web browser. The 3D vehicle scene can present a 3D vehicle model encompassed by multiple selectable damage panels. The 3D interactive vehicle damage claim interface can allow the customer to manipulate the orientation of the 3D vehicle model and assign damage information to the damage panels. As the customer associates damage information to a damage panel, the appearance of a damage skin presented within the damage panel can be dynamically modified in real-time.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

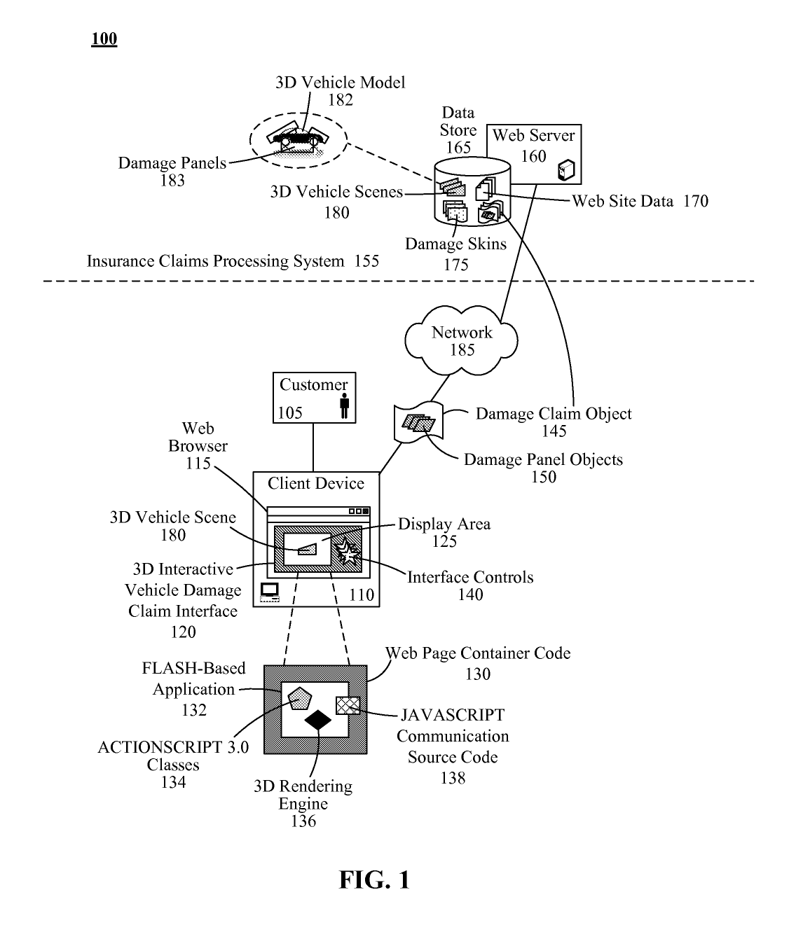

FIG. 1 is a schematic diagram illustrating a system 100 that utilizes a 3-dimensional (3D) interactive vehicle damage claim interface 120 for capturing damage claim data 145 for an insurance claim processing system 155 in accordance with embodiments of the inventive arrangements disclosed herein. In system 100, a customer 105 can utilize the 3D interactive vehicle damage claim interface 120 to capture and convey data packaged as a damage claim object 145 to an insurance claims processing system 155 over a network 185.

The customer 105 can access the 3D interactive vehicle damage claim interface 120 via a Web browser 115 running on a client device 110. The client device 110 can represent a variety of electronic computing devices capable of using a Web browser 115 to interact with the insurance claim processing system 155 over a network 185. Examples of client device 110 can include, but are not limited to, a desktop computer, a laptop computer, a Web-enabled PDA or palmtop computer, a Web-enabled mobile phone, a smart phone, a Web-enabled portable gaming console, and the like.

The Web browser 115 can correspond to the software application installed upon the client device 110 configured to communicate over the network 185 utilizing standardized Web programming languages and protocols, such as hypertext markup language (HTML) and hypertext transfer protocol (HTTP). Using the Web browser 115, the customer 105 can access the 3D interactive vehicle damage claim interface 120 from a Web server 160 associated with the insurance claim processing system 155. That is, in one embodiment, the interface 120 can be a server-based (e.g., server 160) interface that is presentable upon a browser (used generically to encompass a network gadget, a Rich Internet Application (RIA), etc.) of device 110. In another embodiment, interface 120 can be one rendered for a local application running on device 110, which includes an interface of a stand-alone application, an off-line variant of a Web based interface (e.g., an interface enabled through GOOGLE GEARS, for example), etc.

The insurance claim processing system 155 can represent the hardware and/or software components utilized by an insurance company to handle data associated with customer 105 claims. The insurance claim processing system 155 of system 100 can be configured to handle claim related to vehicular damage. Additional types of claims (i.e., property, medical, etc.) may be handled by the insurance claim processing system 155 without adversely affecting embodiments of the disclosure. The insurance claim processing system 155 is to be construed as one embodiment of the disclosure, others of which are contemplated herein. In other contemplated embodiments, for example, the interface 120 or a variant thereof that utilizes model 182 and damage panels 183 can be implemented in a vehicle auctioning system, in a vehicle repair center system, in a police accident database or tracking system, and other such systems. In other words, details of inventive aspects have been expressed within this disclosure in context of an insurance claims processing system 155 for clarity of expression only and are not to be interpreted as a limitation of the scope of the disclosure.

It should be noted that the insurance claim processing system 155 (or other system that implements the inventive aspects expressed herein) can be a subsystem of a larger enterprise computing system (not shown) of the insurance company. Depending upon the network architecture of the insurance claim processing system 155 and/or enterprise computing system, the Web server 160 shown in system 100 need not be a direct component of the insurance claim processing system 155. That is, Web server 160 can be provided by a third-party service vendor external to the insurance claim processing system 155.

The Web server 160 can represent the hardware and/or software components configured to provide access to Web site data 170 residing in a data store 165. The Web site data 170 can correspond to a variety of electronic files and/or documents stored in formats capable of being interpreted and presented by a Web browser 115, such as Web page documents written in HTML. The Web site data 170 can also include auxiliary files and/or documents referenced by other documents such as image files and embedded applications.

The 3D interactive vehicle damage claim interface 120 can represent a software application configured to be run within a Web browser 115 to capture data representing a damage claim being made by the customer's 105. The 3D interactive vehicle damage claim interface 120 can present the customer 105 with a 3D vehicle scene 180 within a display area 125 and various interface controls 140 to facilitate interaction.

As shown in system 100, the 3D interactive vehicle damage claim interface 120 can be a FLASH-based application 132 embedded within Web page container code 130. The Web page container code 130 can represent the code of a Web programming language representing the Web page that displays the 3D interactive vehicle damage claim interface 120 to the customer 105 within the Web browser 115. For example, the Web page container code 130 can correspond to a Web page written in HTML in which the FLASH-based application 132 can be embedded utilizing the SWFObject library. FLASH is one illustrative technology for enabling application 132 and others are contemplated (e.g., Scalable Vector Graphics (SVG) technologies, Synchronized Multimedia Integration Language (SMIL) technologies, JAVA based technologies, ACTIVE X based technologies, etc.).

Other examples of Web page container code 130 can include, but are not limited to, HTML tags and attributes defining a Web page, extensible markup language (XML) tags and attributes defining a Web page, a Web portlet, dynamic HTML (DHTML) tags and attributes defining a Web page, a document defining a Web page that includes a composite of standardized Web programming languages, and the like.

The Web page container code 130 can also include content and/or functionality for other content to be presented within the Web page as well as the JAVASCRIPT communication source code 138. The JAVASCRIPT communication source code 138 can correspond to a set of JAVASCRIPT functions designed to facilitate data exchanges between the Web page container code 130 and the FLASH-based application 132. For example, the FLASH-based application 132 can utilize the ACTIONSCRIPT 3.0 ‘ExternalInterface’ class 134 to pass collected data to the Web page container code 130 for transmission to the insurance claim processing system 155.

The FLASH-based application 132 can include ACTIONSCRIPT 3.0 classes 134 and a 3D rendering engine 136 such as PAPERVISION3D. The ACTIONSCRIPT 3.0 classes 134 can correspond to groupings of functions written in the ACTIONSCRIPT 3.0 language that support operation of the 3D interactive vehicle damage claim interface 120, such as passing collected data using the ‘ExternalInterface’ class as mentioned above. Further, the ACTIONSCRIPT 3.0 classes 134 can support the functionality of the interface controls 140.

Appendix A includes a further elaboration (i.e., provides a more robust implementation example of the elements of the 3D interactive vehicle damage claim interface 120) than shown in system 100. It is provided for illustrative purposes only and the specifics expressed in Appendix A are not to be construed as a limitation of the scope of the invention described herein. Appendix A is being submitted separately in an ASCII.txt file format in accordance with MPEP §1.96(c).

The 3D rendering engine 136 can be used by the 3D interactive vehicle damage claim interface 120 to render the 3D vehicle scene 180 in real-time. The 3D vehicle scene 180 can be stored in a data store 165 of the Web server 160 in a standardized format, such as the collaborative design activity (COLLADA) format, and represent a composite of a 3D vehicle model 182 and associated damage panels 183.

The 3D vehicle model 182 can be a 3-dimensional representation of a specific vehicle, which can also utilize the COLLADA format. The insurance claim processing system 155 can be configured to automatically provide the customer 105 with a 3D vehicle scene 180 that contains a 3D vehicle model 182 matching the year, model, and make of the actual vehicle registered by the customer 105. For example, a customer 105 having insured a 2003 FORD ESCAPE would be provided with a 3D vehicle scene 180 whose 3D vehicle model 182 matches a 2003 FORD ESCAPE.

In the situation where a customer 105 has multiple vehicles registered with the insurance claim processing system 155, the 3D interactive vehicle damage claim interface 120 can be configured to request the specification of a registered vehicle by the customer 105.

The damage panels 183 can represent predefined 3-dimensional planes that correspond to the underlying areas of the 3D vehicle model 182. Selection of a damage panel 183 can allow the customer 105 to configure the appearance and/or location of damage to that area of the 3D vehicle model 182. For example, selecting the damage panel 183 positioned over the hood of the 3D vehicle model 182 can allow the customer 105 to enter data into the 3D interactive vehicle damage claim interface 120 that describes the damage to the hood of their real vehicle.

When the customer 105 selects a type of damage to add to a damage panel 183, the 3D interactive vehicle damage claim interface 120 can retrieve a matching damage skin 175 from the Web server 160 data store 165. The damage skin 175 can be a type of graphic designed to illustrate a specific damage type, such as a scratch or dent. The 3D interactive vehicle damage claim interface 120 can overlay the damage skin 175 onto the area bound by the damage panel 183 on the 3D vehicle model 182.

The customer 105 can then be presented with interface controls 140 specific to the customization of the damage skin 175 within the 3D vehicle scene 180. As the customer 105 changes using the interface controls 140, the graphic of the damage illustrated by the damage skin 175 can dynamically adjust to match the entered changes. For example, a scratch damage skin 175 rendered on the hood damage panel 183 can be enlarged and/or deepened in real-time as the customer 105 modifies parameter values representing the magnitude and/or severity of the damage.

Additionally, the customer 105 can use an interface control 140 or input mechanism (not shown), such as a mouse or stylus, to select the graphic of the damage presented by the damage skin 175 and move the graphic to another position within the damage panel 183. For example, by selecting the scratch damage graphic the customer 105 can reposition the scratch upon the hood damage panel 183 to mirror the positioning of the scratch on the actual vehicle.

In one embodiment, the Web server 160 and damage skins 175 can be extended to permit a reshaping of a vehicle model 182 to adjust for damage to a base vehicle. For example, in an event of a front-end collision, an overall shape of a vehicle is expected to be compressed from a baseline shape. Digital signal processing techniques can be used to alter the vehicle shape shown in interface 120 in a manner consistent with the applied damage skins 175 and consistent with a set of known damage panel objects 150. Further, the objects 150 can be cross-checked for consistency and inferences can be made. In one embodiment, a customer 105 can be prompted based on these inferences (i.e., frame damage may be inferred that is not explicitly input by customer 105, who is optionally prompted to confirm inferred information about a vehicle). In one embodiment, a set of one or more pictures, video, or other representation of a vehicle can be optionally entered as input, which can be analyzed and cross-checked against other customer 105 entered values. That is, analyzed results of images can be converted into and/or compared against damage panel objects 150 of a damage claim object 145 and information contained therein. Consistency checks and/or consistency adjustments can be performed based on these comparison results.

Data entered by the customer 105 for a damage panel 183 can be captured by the 3D interactive vehicle damage claim interface 120 as a damage panel object 150. When the customer 105 is finished entering data and wishes to submit their claim to the insurance claim processing system 155, the 3D interactive vehicle damage claim interface 120 can package all the damage panel objects 150 into a damage claim object 145.

The damage claim object 145 can represent the data entered by the customer 105 to make a damage claim to the insurance claim processing system 155. In addition to the damage panel objects 150, the damage claim object 145 can include additional identifying information (not shown) for the customer 105. This additional identifying information can be data that was extracted from the insurance claim processing system 155 (or larger enterprise computing system) and sent to the Web browser 115 or new data directly entered by the customer 105 into the 3D interactive vehicle damage claim interface 120.

For example, after the customer 105 logs into the insurance claim processing system 155, a username associated with the customer 105 can be displayed within the Web page displayed by the Web browser 115. This username can then be extracted from the Web page container code 130 for use in the damage claim object 145.

Further, the additional identifying information may be hidden from the customer's 105 view within the Web page. For example, the Web server 160 can generate a unique session number and include the session number as a hidden field within the Web page container code 130. The session number can be extracted from the Web page container code 130 for use in the damage claim object 145, but the customer 105 is unable to view the session number within the Web browser 115.

Additionally and as previously mentioned, the damage claim object 145 and/or damage panel objects 150 can be configured to allow the inclusion of image files uploaded by the customer 105 (or police, repair center, insurance adjuster, etc.), when supported by the insurance claim processing system 155 and 3D interactive vehicle damage claim interface 120. For example, the customer 105 can upload a digital image of the area on the actual vehicle being described by the damage panel object 150. These images can be stored discretely in the system 155 and/or adjustments can be made based on the images (as previously detailed) depending on implementation choices for system 155.

The 3D interactive vehicle damage claim interface 120 can be further configured to store damage claim objects 145 to a data store (not shown) local to the client device 110 for future use. For example, the customer 105 may not be able to complete entry into the 3D interactive vehicle damage claim interface 120 at one time, and, therefore, can save their progress locally to finish at a later time.

Further, the 3D interactive vehicle damage claim interface 120 can be configured to save the 3D vehicle scenes 180 usable by the customer 105 in a local data store (not shown) of their client device. This configuration can expedite rendering of the 3D vehicle scene 180 within the 3D interactive vehicle damage claim interface 120.

Network 185 can include any hardware/software/and firmware necessary to convey data encoded within carrier waves. Data can be contained within analog or digital signals and conveyed though data or voice channels. Network 185 can include local components and data pathways necessary for communications to be exchanged among computing device components and between integrated device components and peripheral devices. Network 185 can also include network equipment, such as routers, data lines, hubs, and intermediary servers which together form a data network, such as the Internet. Network 185 can also include circuit-based communication components and mobile communication components, such as telephony switches, modems, cellular communication towers, and the like. Network 185 can include line based and/or wireless communication pathways.

As used herein, presented data store 165 can be a physical or virtual storage space configured to store digital information. Data store 165 can be physically implemented within any type of hardware including, but not limited to, a magnetic disk, an optical disk, a semiconductor memory, a digitally encoded plastic memory, a holographic memory, or any other recording medium. Data store 165 can be a stand-alone storage unit as well as a storage unit formed from a plurality of physical devices. Additionally, information can be stored within data store 165 in a variety of manners. For example, information can be stored within a database structure or can be stored within one or more files of a file storage system, where each file may or may not be indexed for information searching purposes. Further, data store 165 can utilize one or more encryption mechanisms to protect stored information from unauthorized access.

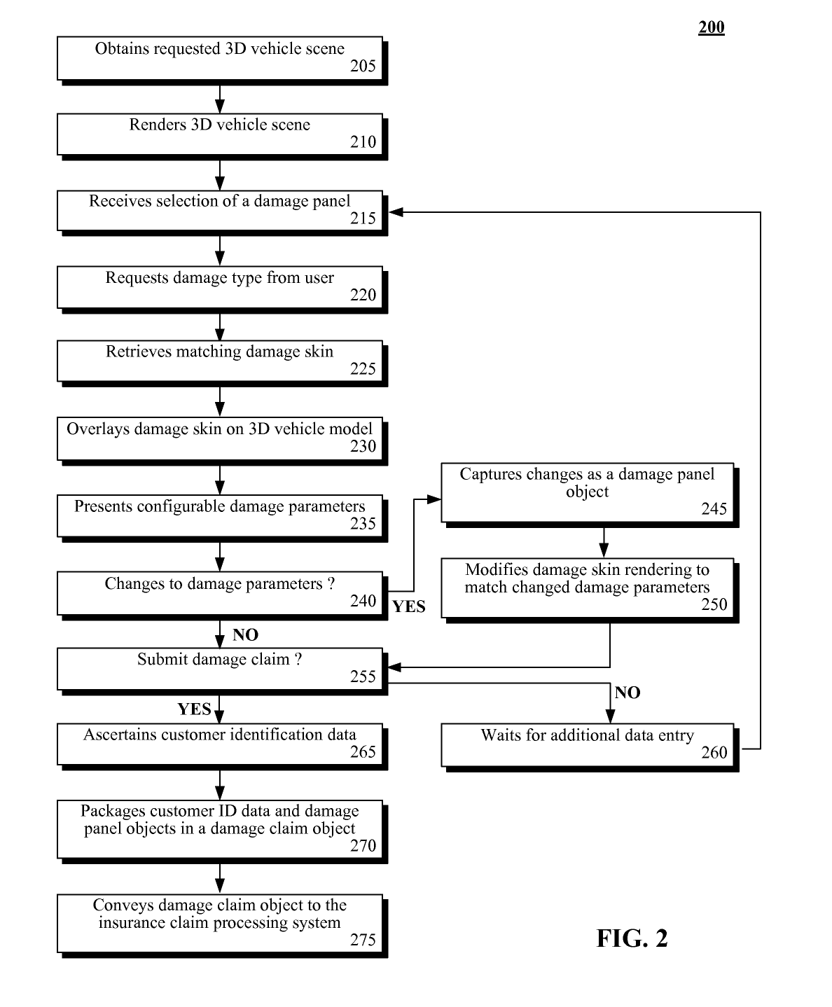

FIG. 2 is a flow chart of a method 200 describing the basic operation of a 3D interactive vehicle damage claim interface in accordance with embodiments of the inventive arrangements disclosed herein. Method 200 can be performed within the context of system 100 or any other system configured to render 3D vehicle scenes within a Web browser for the purpose of collecting vehicle damage claim information.

Method 200 can begin in step 205 where the 3D interactive vehicle damage claim interface can obtain the requested 3D vehicle scene from the insurance claim processing system (or other system implementing inventive aspects detailed herein). Step 205 can occur after a customer has requested use of the 3D interactive vehicle damage claim interface from a Web page presented by the Web browser. The requested 3D vehicle scene can be manually designated in the preceding Web page by the customer or can be automatically determined by the insurance claim processing system.

It should be noted that the customer would most likely designate a vehicle type (i.e., year, make, and model) and not the identifier of the 3D vehicle scene. Either the 3D interactive vehicle damage claim interface or insurance claim processing system can be configured to determine the appropriate 3D vehicle scene for a user-designated vehicle type.

The requested 3D vehicle scene can then be rendered by the 3D interactive vehicle damage claim interface within the Web browser in step 210. In step 215, selection of a damage panel within the 3D vehicle scene by the customer can be received. A damage type can be requested from the customer in step 220.

In step 225, the damage skin matching the customer-specified damage type can be retrieved from the insurance claim processing system. The retrieved damage skin can be overlaid on the 3D vehicle model within the 3D vehicle scene in step 230.

In step 235, the customer can then be presented with configurable damage parameters for the selected damage panel. Changes to the damage parameters can be detected in step 240.

When the customer has made changes to the damage parameters, flow can proceed to step 245 where the changes can be captured as a damage panel object. The rendering of the damage skin can be modified in step 250 to match the changed damage parameters.

Upon completion of step 250 or when no changes have been made to the damage parameters, step 255 can be performed where it can be determined if the customer has elected to submit the damage claim. When the customer has not yet elected to submit the damage claim, the 3D interactive vehicle damage claim interface can wait for additional data entry in step 260. From step 260, flow of method 200 can return to step 215 with the selection of another damage panel.

When the customer elects to submit the damage claim, step 265 can be performed where customer identification data can be ascertained. The customer identification data and damage panel objects can be packaged in a damage claim object in step 270. In step 275, the damage claim object can be conveyed to the insurance claim processing system.

Another embodiment of method 200 can include a branch to handle saving the changes inputted by the customer for future submission to the insurance claim processing system, when supported by the 3D interactive vehicle damage claim interface.

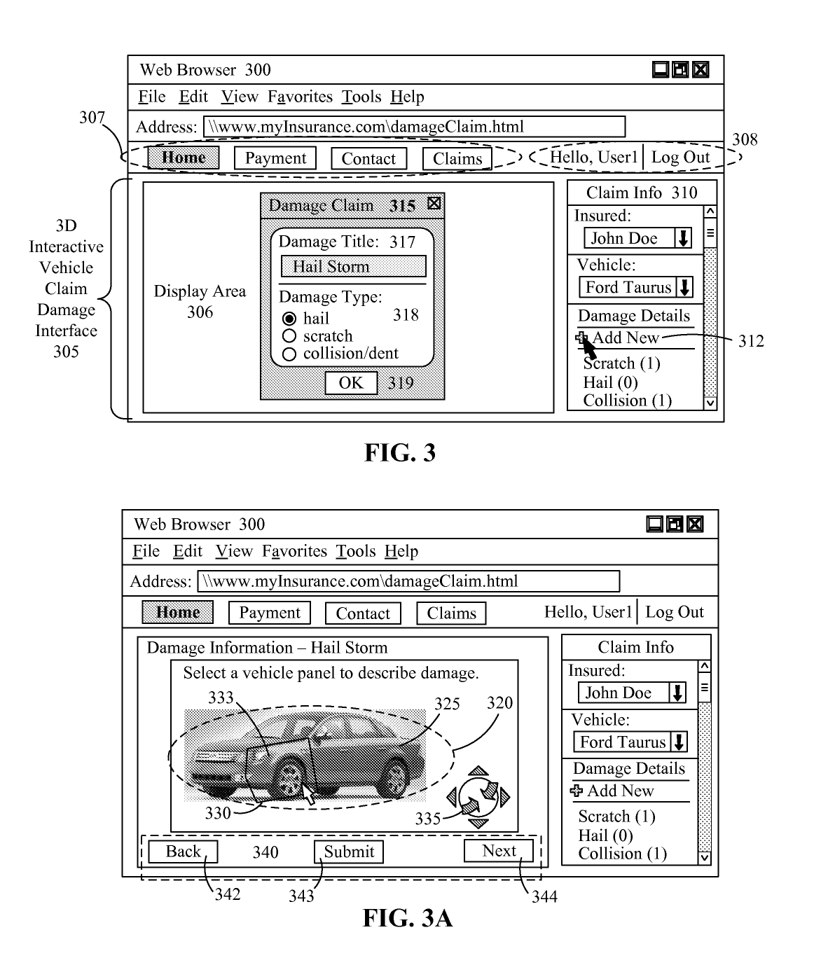

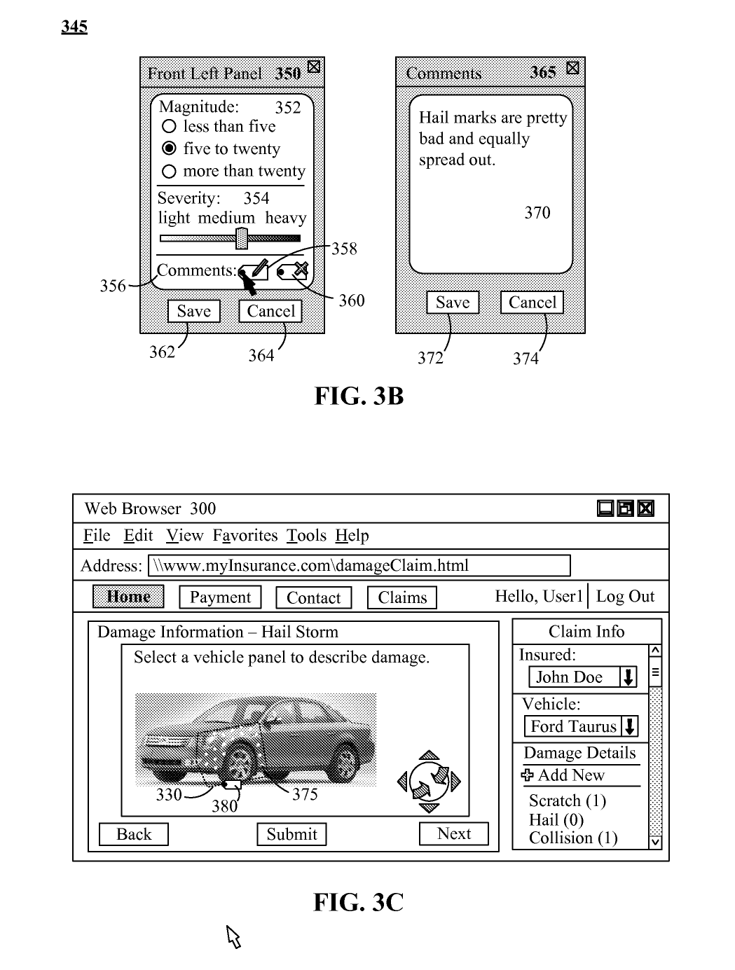

FIG. 3 is an illustration of an example 3D interactive vehicle damage claim interface 305 as presented within a Web browser 300 in accordance with embodiments of the inventive arrangements disclosed herein. Example 3D interactive vehicle damage claim interface 305 can be utilized within the context of system 100 and/or in conjunction with method 200.

It is important to note that the example 3D interactive vehicle damage claim interface 305 shown in FIG. 3 is for illustrative purposes only, and is not intended to present an exhaustive embodiment of the present invention.

In this example, the customer has requested use of the 3D interactive vehicle damage claim interface 305 from the insurance claim processing system. Depending upon the Web site architecture used by the insurance claim processing system, other content elements 307 and 308 can be presented within the Web browser 300 in addition to the 3D interactive vehicle damage claim interface 305.

As shown in FIG. 3, a set of site navigation buttons 307 and customer login information 308 can be displayed with the 3D interactive vehicle damage claim interface 305. The 3D interactive vehicle damage claim interface 305 can include a display area 306 and a claim information area 310.

The display area 306 can represent a defined space of the 3D interactive vehicle damage claim interface 305 in which damage data can be interactively captured. The claim information area 310 can represent the portion of the 3D interactive vehicle damage claim interface 305 configured to present the customer with the ability to perform and/or define general data, such as the name of the insured and vehicle shown in this example.

The claim information area 310 can also include a user-selectable mechanism 312 (i.e., button) for initiating the entry of damage claim data. Selection of this mechanism 312 can result in the presentation of a damage claim window 315.

The damage claim window 315 can present the customer with modifiable fields for capturing basic details regarding the damage claim being made. As shown in this example, the damage claim window 315 can include a damage title field 317 and a damage type selector 318.

The damage title field 317 can capture a user-defined textual name for the damage claim. The damage type selector 318 can allow the customer to select from a predefined list the type damage being represented in the damage claim.

In one embodiment, the designation of the damage type selector 318 can be performed as part of entering data for a specific damage panel. That is, the damage type selector 318 can be implemented at the damage panel level and not at the damage claim level. Further, in one embodiment, graphical tools can be included for visually showing damage. For example, a user can select among a set of “divots” or concavities (caused by hail, for example) and visibly draw damage on an image of the vehicle in scene 320. For example, a graphical editor can include a toolbar containing selectable types of “damage” icons or tools, which can be used to modify a vehicle shown in a canvas. Thus, a graphical damage editor can replace and/or supplement a text or selection interface (e.g., shown in window 315) in one contemplated embodiment.

Once values have been entered for the damage title field 317 and damage type selector 318, the customer can select the OK button 319 for the 3D interactive vehicle damage claim interface 305 to retrieve and present the appropriate 3D vehicle scene 320, as shown in FIG. 3A.

In FIG. 3A, the 3D interactive vehicle damage claim interface 305 can present the appropriate 3D vehicle scene 320 based upon the values in the claim information area 310 of FIG. 3 within the display area 306. Therefore, in this example, the 3D vehicle scene 320 contains a 3D vehicle model 325 of a FORD TAURUS.

Damage panels 330 can also be included in the 3D vehicle scene 320. Visual presentation of the damage panels 330 can depend upon the implementation of the 3D interactive vehicle damage claim interface 305. As shown in this example, the damage panels 330 can remain hidden until activated by the customer, such as the placing the mouse pointer in an area of the 3D vehicle model 325 having a damage panel 330.

Additional visual cues and coloration can be utilized when presenting the damage panels 330. For example, the damage panel 330 can have a certain degree of transparency when selected or a modified damage panel 330 can be outlined in a different color than unmodified damage panels 330.

Depending on the implementation, as mentioned in the description of FIG. 3, the damage panel 330 can be loaded with a damage skin 333 representing the selected damage type 318. As shown in this example, the damage skin 333 can contain a dot pattern to generically represent hail damage in the area bound by the damage panel 330.

The display area 306 can also include a set of rotational controls 335 that the customer can use to change the orientation of the 3D vehicle scene 320. Changing the orientation of the 3D vehicle scene 320 can allow the customer to better visualize and position the damage within the damage panel 330.

For example, if the 3D vehicle model 325 used in this example was rendered as a static image, it could be difficult for the customer to accurately determine the placement of a damage skin on the roof damage panel 330. However, with the 3D interactive vehicle damage claim interface 305, the customer can easily use the rotational controls 335 to reposition the 3D vehicle model 325 as if they were viewing the 3D vehicle model 325 from above, allowing for full visibility of the roof.

The display area 306 can further include a set of application buttons 340 to allow the customer to perform additional actions for the creating their damage claim. In this example, the set of application buttons 340 can include a BACK button 342 and a NEXT button 344 for controlling the progression of the overall claim entry process as well as a SUBMIT button 343 to send the completed damage claim to the insurance claim processing system.

The functions provided by the rotational controls 335 and/or application buttons 340 can be implemented in alternate fashions, such as menu commands or customer manipulation of the client device, supported by the 3D interactive vehicle damage claim interface 305, the Web browser 300, insurance claim processing system, and/or client device. For example, with a client device having a touch screen display, the rotational controls 335 can utilize the tactile feedback of the customer moving the 3D vehicle scene 320 within the display area 306 to rotate the 3D vehicle model 325.

Upon selection of the damage panel 330, the customer can be presented with one or more windows to enter the specific details of the damage contained in the selected damage panel 330, such as those illustrated in collection 345 of FIG. 3B. The panel window 350 of collection 345 can present the customer with configurable parameters for the selected damage type 318.

As shown in this example, the panel window 350 can include parameters for defining the magnitude 352 and severity 354 of the hail damage, a comments control 356, a SAVE button 362, and a CANCEL button 364. Selection of the SAVE button 362 can store any data entered/changed in the panel window 350 to a damage panel object. The CANCEL button 364 can discard any changes made to the panel window 350, close the panel window 350, and return the customer to scene shown in FIG. 3A.

The magnitude 352 parameter can allow the customer to input or select a value that best describes the amount of damage to the specific damage panel 330. In this example, the customer can select the radio button associated with the textual quantification that represents the quantity of hail damage indentations on the front left panel 330 of their vehicle.

The severity 354 parameter can provide the customer with the means to express the size of the damage. In this example, the severity 354 parameter utilizes a slider bar mechanism for adjusting the size of the hail damage indentations.

It should be appreciated that changes made to either the magnitude 352 or severity 354 parameters by the customer can dynamically alter the presentation of the damage skin 333 within the selected damage panel 330. That is, the panel window 350 can be positioned to allow the customer to view the selected damage panel 330 as changes are made.

For example, when the customer selects the “five to twenty” magnitude 352, the quantity of dots presented in the damage skin 333 can be reduced to a quantity in this range automatically and in real-time. The rendering of the damage skin 333 can be dynamically changed by the 3D interactive vehicle damage claim interface 305.

It is also important to note that the parameters shown in the panel window 350 are only illustrative in nature. Other means of quantifying and/or describing the damage can be utilized without straying from the intent of this embodiment of the present invention. Further, multiple panel windows 350 can be used to support collection of the damage information.

The comments control 356 can provide the customer with the ability to enter textual information for the damage panel 330. In this example, the comments control 356 can include selectable commands to edit 358 or delete 360 a comment. The delete 360 command can remove the comment information from the damage panel object associated with the damage panel 330.

Selection of the edit 358 command can present the customer with a comments window 365. The comments window 365 can allow the customer to enter text into a text field 370. The customer can then select the SAVE button 372 or CANCEL button 374. Selecting the SAVE button 372 can store the text entered in the text field 370 in the damage panel object, whereas selection of the CANCEL button 374 can discard the text entered into the text field 370. The comments window 365 can be closed after selection of either the SAVE button 372 or CANCEL button 374.

After saving changes made within the panel window 350 and/or comments window 365, the 3D interactive vehicle damage claim interface 305 can appear as shown in FIG. 3C. The selected damage panel 330 can now present a damage skin 375 that corresponds to the parameter 352 and 354 values entered/modified in the panel window 350. Additionally, the existence of customer comments for the selected damage panel 330 can be visually indicated using a comments graphic 380 that can be displayed when the damage panel 330 is selected by the customer.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for handling vehicle damage using a user interface comprising:
modeling a vehicle using a three-dimensional vehicle model stored on a tangible storage medium;
defining a plurality of vehicle panels for the vehicle model, each of the vehicle panels corresponding to a specific one of a plurality of different discrete vehicle regions of the vehicle model, each of the vehicle panels comprising a three dimensional plane for an exterior of the outer surface of the vehicle;
rendering, via at least one computer program product executing on hardware, an image of the vehicle within an interactive user interface, said image being generated from the three-dimensional vehicle model;
detecting a presence of an interface pointer positioned over the image;
responsive to the detecting, determining one of the vehicle panels corresponding to one of the discrete vehicle regions that the interface pointer is pointing at a time of the detecting;
showing the determined one of the vehicle panels in a visually delineated manner within the user interface, wherein determined one of the vehicle panels is shown overlaying the corresponding one of the discrete regions of the image;
presenting damage fields within the user interface for defining damage to vehicle panels, wherein binding of the data fields are adjusted so that the damage fields refer to the determined one of the vehicle panels;
receiving damage input entered into the damage fields, said damage input being specific to the determined one of the vehicle panels;
storing the damage input within a damage panel object corresponding to the determined one of the vehicle panels;
detecting a repositioning of the interface pointer so that it is no longer pointing to the determined one of the panels; and
responsive to detecting the repositioning, hiding the determined one of the vehicle panels within the user interface so that the user interface no longer shows the determined one of the vehicle panels as overlaying the corresponding one of the discrete regions of the image; and
responsive to detecting the repositioning, adjusting bindings of the damage fields so that the damage fields do not refer to the determined one of the vehicle panels or so that the damage fields are no longer presented within the user interface.

2. The method of claim 1, further comprising:
automatically presenting a previously hidden pop-up window comprising the damage fields responsive to showing the detecting the presence of the interface pointer as being positioned over the image; and
wherein the repositioning of the interface pointer places the interface pointer outside boundaries of the image, responsive to the repositioning of the interface pointer, automatically hiding the pop-up window comprising the damage fields.

3. The method of claim 1, wherein the image is enabled for mouse-over-events, wherein positioning the interface pointer in a stationary position over the image for a fixed duration results in triggering a mouse-over event, which causes a previously hidden vehicle panel positioned under the interface pointer to be dynamically shown.

4. The method of claim 1, wherein the determined one of the vehicle panels has a transparency value between twenty-five and seventy-five percent when shown in the graphical user interface.

5. The method of claim 1, further comprising:
presenting within the user interface, at least one user control enabling a user to rotate the image of the vehicle to any user desired viewing angle, wherein use of the user control causes a re-rendering of the image, wherein the re-rendering is generated from the three-dimensional vehicle model, and wherein when the image is re-rendered while the determined one of the vehicle panels is shown, the determined one of the vehicle panels is adjusted so that it is shown as overlaying the corresponding one of the discrete regions of the image as adjusted.

6. The method of claim 1, further comprising:
responsive to receiving the damage input, determining at least one damage overlay object, wherein a damage overlay object represents a visual depiction of a type of damage to the vehicle, wherein said damage overlay object corresponds to content of the damage input;
responsive to the determining of the at least one damage overlay, presenting the damage overlay on top of the image, so that the visual depiction of the type of damage is shown when viewing the image of the user interface; and
persisting the damage overlay in the image when the determined one of the vehicle panels is hidden, wherein the persisting of the damage overlay is maintained while the image is presented and while the damage panel object is stored that includes damage input corresponding to the damage overlay.

7. The method of claim 6, wherein each of the at least one damage overlays has a transparency value between twenty-five and seventy-five percent when shown in the user interface.

8. The method of claim 6, further comprising:
presenting within the user interface, at least one user control enabling a user to rotate the image of the vehicle to any user desired viewing angle, wherein use of the user control causes a re-rendering of the image, wherein the re-rendering is generated from the three-dimensional vehicle model, and wherein when the image is re-rendered while the at least one damage overlay is shown, the at least one damage overlay is adjusted so that it is shown as overlaying the corresponding part of the image as adjusted.

9. The method of claim 1, wherein an outer surface of the vehicle is completely defined by the sum of the vehicle panels, which join in a non-overlapping and seamless matter.

10. A computer program product comprising a computer readable storage medium having computer usable program code embodied therewith, the computer usable program code comprising:
computer usable program code operable to model a vehicle using a three-dimensional vehicle model stored on a tangible storage medium;
computer usable program code operable to define a plurality of vehicle panels for the vehicle model, each of the vehicle panels corresponding to a specific one of a plurality of different discrete vehicle regions of the vehicle model, each of the vehicle panels comprising a three dimensional plane for an exterior of the outer surface of the vehicle;
computer usable program code operable to render, via at least one computer program product executing on hardware, an image of the vehicle within an interactive user interface, said image being generated from the three-dimensional vehicle model;
computer usable program code operable to detect a presence of an interface pointer positioned over the image;
computer usable program code operable to, responsive to the detecting, determine one of the vehicle panels corresponding to one of the discrete vehicle regions that the interface pointer is pointing at a time of the detecting;
computer usable program code operable to show the determined one of the vehicle panels in a visually delineated manner within the user interface, wherein determined one of the vehicle panels is shown overlaying the corresponding one of the discrete regions of the image;
computer usable program code operable to present damage fields within the user interface for defining damage to vehicle panels, wherein binding of the data fields are adjusted so that the damage fields refer to the determined one of the vehicle panels;
computer usable program code operable to receive damage input entered into the damage fields, said damage input being specific to the determined one of the vehicle panels;
computer usable program code operable to store the damage input within a damage panel object corresponding to the determined one of the vehicle panels;
computer usable program code operable to detect a repositioning of the interface pointer so that it is no longer pointing to the determined one of the panels; and
computer usable program code operable to, responsive to detecting the repositioning, hide the determined one of the vehicle panels within the user interface so that the user interface no longer shows the determined one of the vehicle panels as overlaying the corresponding one of the discrete regions of the image; and
computer usable program code operable to, responsive to detecting the repositioning, adjust bindings of the damage fields so that the damage fields do not refer to the determined one of the vehicle panels or so that the damage fields are no longer presented within the user interface.

11. A method for capturing vehicle damage information in an interactive graphical user interface (GUI) comprising:
rendering a three-dimensional vehicle scene within an interactive user interface, wherein said three-dimensional vehicle scene comprises an image of a vehicle generated from a three-dimensional vehicle model, wherein the image of the vehicle within the three-dimensional vehicle scene is rotatable by user selections of user selectable rotation controls of the interactive user interface;
showing and hiding vehicle panels within the interactive user interface responsive to positionings of an interface pointer of the user interface relative to the image of the vehicle, wherein each vehicle panels comprises a three dimensional plane for an exterior of the outer surface of the vehicle, wherein each vehicle panel is shown in the interactive user interface as an overlay to a portion of the image of the vehicle that corresponds to the vehicle panel, wherein adjustments to the vehicle panels are made when the image of the vehicle is rotated by user selections of the rotation controls;
while one of the vehicle panels is shown, presenting a plurality of user-configurable damage fields to describe damage to the vehicle within a region of the vehicle corresponding to the one vehicle panel that is shown;
responsive to changes to values of the user configurable damage fields, determining damage to said vehicle; and
visually presenting the determined damage in its corresponding location of the image within the interactive user interface.

12. The method of claim 11, wherein the visually presenting of the determined damage is shown within each of the vehicle panels only when the corresponding vehicle panel is shown and is not hidden.

13. The method of claim 11, wherein the visually presenting of the determined damage occurs by changing the image to include visual indications of the determined damage.

14. The method of claim 11, wherein the visually presenting of the determined damage occurs by showing damage overlay objects representing the determined damage in the interactive user interface, wherein the damage overlay objects overlay the image and are distinct from the image.

15. The method of claim 11, further comprising:
utilizing the values input in the damage fields to indicate vehicle damage within an insurance claim as stored within an insurance claims processing system.

16. The method of claim 11, wherein damage panel objects are stored within a storage area and are used to store the values of the user-configurable damage fields, and wherein the three-dimensional vehicle model used to generate the image of the vehicle is not modified when the determined damage is visually presented in the interactive user interface, wherein a combination of data in the damage panel objects and the three-dimensional vehicle model is used to generate the image of the vehicle and the determined damage that are shown in the interactive user interface.

17. The method of claim 11, wherein the vehicle image is that of an undamaged vehicle generated from the three-dimensional vehicle model, said method further comprising:
dynamically creating the vehicle scene at runtime in real-time within the interactive user interface by combining the image and graphical indicia of damage, wherein the damage is established by the values input into the user configurable damage fields, wherein the vehicle scene shows a damaged vehicle in accordance with the image overlaid with the graphical indicia of damage.

18. The method of claim 11, wherein the graphical indicia of damage and the vehicle panels are rendered as semi-transparent objects having a transparency value between twenty-five and seventy-five percent.

19. The method of claim 11, wherein the showing and hiding of the vehicle panels occurs responsive to mouse-over events, wherein the plurality of user-configurable damage fields is presented within a pop-up window, wherein bindings to the user-configurable damage fields automatically change depending on which of the vehicle panels is selected within the interactive user interface.

20. A computer program product comprising a computer readable storage medium having computer usable program code embodied therewith, the computer usable program code comprising:
computer usable program code operable to render a three-dimensional vehicle scene within an interactive user interface, wherein said three-dimensional vehicle scene comprises an image of a vehicle generated from a three-dimensional vehicle model, wherein the image of the vehicle within the three-dimensional vehicle scene is rotatable by user selections of user selectable rotation controls of the interactive user interface;
computer usable program code operable to show and hide vehicle panels within the interactive user interface responsive to positionings of an interface pointer of the user interface relative to the image of the vehicle, wherein each vehicle panels comprises a three dimensional plane for an exterior of the outer surface of the vehicle, wherein each vehicle panel is shown in the interactive user interface as an overlay to a portion of the image of the vehicle that corresponds to the vehicle panel, wherein adjustments to the vehicle panels are made when the image of the vehicle is rotated by user selections of the rotation controls;
computer usable program code operable to, while one of the vehicle panels is shown, present a plurality of user-configurable damage fields to describe damage to the vehicle within a region of the vehicle corresponding to the one vehicle panel that is shown;
computer usable program code operable to, responsive to changes to values of the user configurable damage fields, determine damage to said vehicle; and
computer usable program code operable to visually present the determined damage in its corresponding location of the image within the interactive user interface.
